(19) United States
(12) Patent Application Publication
(10) Pub. No.: US 2016/0039677 A1
(43) Pub. Date: Feb. 11, 2016

(54) DIRECT COMBUSTION HEATING

(71) Applicant: SEERSTONE LLC, Provo, UT (US)

(72) Inventor: Dallas B. Noyes, Provo, UT (US)

(73) Assignee: SEERSTONE LLC, Provo, UT (US)

(21) Appl. No.: 14/775,906

(22) PCT Filed: Mar. 12, 2014
(86) PCT No.: PCT/US2014/025065

§ 371 Date: Sep. 14, 2015

Related U.S. Application Data
(60) Provisional application No. 61/789,887, filed on Mar. 15, 2013.

(51) Int. Cl. C01B 31/02; B01J 19/24

(52) U.S. Cl. CPC C01B 31/0226; B01J 19/245; B01J 2219/24; B01J 2219/00103

(57) ABSTRACT

An electrode includes a network of compressed interconnected nanostructured carbon particles such as carbon nanotubes. Some nanostructured carbon particles of the network are in electrical contact with adjacent nanostructured carbon particles. Electrodes may be used in various devices, such as capacitors, electric arc furnaces, batteries, etc. A method of producing an electrode includes confining a mass of nanostructured carbon particles and densifying the confined mass of nanostructured carbon particles to form a cohesive body with sufficient contacts between adjacent nanostructured carbon particles to provide an electrical path between at least two remote points of the cohesive body. The electrodes may be sintered to induce covalent bonding between the nanostructured carbon particles at contact points to further enhance the mechanical and electrical properties of the electrodes.

### PRIORITY CLAIM

This application claims the benefit of the filing date of U.S. Provisional Patent Application Ser. No. 61/789,887, filed Mar. 15, 2013, for “Direct Combustion Heating” the contents of which are incorporated herein by this reference.

### TECHNICAL FIELD

Embodiments of the disclosure relate to the direct heating of gases by combustion to form heated reaction gases.

### BACKGROUND

U.S. Patent Publication No. 2012/0034150 A1, published Feb. 9, 2012, the disclosure of which is hereby incorporated herein in its entirety by this reference, discloses background information hereto.

Heated reaction gases may be used to form solid products, such as carbon. Carbon oxides, particularly carbon dioxide (CO₂), are abundant gases that may be formed, for example, by combustion of hydrocarbons. Carbon oxides react to form solid carbon at high temperatures (e.g., at temperatures in the range of approximately 450° C. to 1000° C.) in the presence of catalysts. Metals and alloys commonly used to form industrial equipment, such as steel, stainless steels, etc., may serve as catalysts. To avoid the premature reaction of heated carbon oxide gases, reaction equipment may be formed of ceramics and other materials that do not catalyze reactions of heated gases. Materials of construction for the reaction equipment are typically selected to withstand the operating temperatures, metal dusting, and corrosive gas mixtures.

Solid carbon has numerous commercial applications. These applications include uses of carbon black and carbon fibers as filler materials in tires, inks, etc., uses for various forms of graphite (such as the uses of artificial graphite and of pyrolytic graphite), and innovative and emerging applications for buckminsterfullerene and carbon nanotubes. Conventional methods for the manufacture of various forms of solid carbon typically involve the pyrolysis of hydrocarbons in the presence of a suitable catalyst. The use of hydrocarbons as the carbon source in solid carbon production is due to historically abundant availability and low cost of hydrocarbons.

CNTs are valuable because of their unique material properties, including strength and thermal and electrical conductivity. Conventional bulk use of CNTs includes use as an additive to resins in the manufacture of composites. Research and development on the applications of CNTs is very active, with a wide variety of applications in use or under consideration. One obstacle to widespread use of CNTs, however, has been the cost of manufacture. For example, reaction conditions for some processes may require vessels capable of heating reaction gases without corroding the vessels (sometimes referred to in the art as “metal dusting”). It would therefore be beneficial to provide methods of producing reaction gases at conditions conducive to directly forming CNTs.

### DISCLOSURE

In some embodiments, a method includes mixing oxygen with a reducing gas in a vessel having an interior temperature above a reaction temperature of the reducing gas with oxygen. The reducing gas may be hydrogen, a hydrocarbon, an alcohol, etc. A catalyst may be used to promote the reaction of the reducing gas with oxygen. At least a portion of the oxygen reacts with at least a portion of the reducing gas to form at least one carbon oxide and usually water in a heated reaction gas mixture. The heated reaction gas mixture subsequently reacts, in the presence of a catalyst, to form a tail gas and at least one of a solid carbon product and a hydrocarbon.

In other embodiments, a reactor system includes a heater and a reactor. The heater includes a vessel, a first gas inlet configured to deliver a preheated first feed gas into the vessel, a second gas inlet configured to deliver a second feed gas into the vessel, and a gas outlet configured to deliver a reaction gas mixture formed from the reaction of at least a portion of the heated first feed gas with at least a portion of the second feed gas. The reactor includes an inlet configured to receive the reaction gas mixture from the heater, a first outlet configured to deliver a solid or liquid product from the reactor, a catalyst material formulated to promote the formation of solid carbon, and a tail gas outlet configured to deliver a tail gas from the reactor.

Some methods of forming solid carbon include reacting oxygen with at least one hydrocarbon to form water and at least one carbon oxide in a heated reaction gas mixture, and reacting the heated reaction gas mixture in the presence of a catalyst to form a tail gas comprising water and a solid carbon product. The solid carbon product may include graphite, graphene, carbon black, fibrous carbon, buckminsterfullerene, single-wall carbon nanotubes, multi-walled carbon nanotubes, platelets, or nanodiamond.

### BRIEF DESCRIPTION OF THE DRAWINGS

FIGS. 1 through 3 each illustrate simplified process flow diagrams showing processes and systems of the current disclosure; and

FIG. 4 depicts a C—H—O equilibrium diagram, illustrating some chemical reactions that may occur in embodiments of the present disclosure.

### MODE(S) FOR CARRYING OUT THE INVENTION

The disclosure includes methods heating a reaction gas mixture by direct combustion of a portion of a reaction gas mixture using oxygen in a reaction zone, wherein the oxygen level is controlled below explosive limits and the resulting heat of combustion brings the resulting heated gas mixture to the desired operating temperature.

In some embodiments, the oxygen is introduced into the reaction gas mixture and immediately combusted, as in a furnace. In other embodiments the oxygen is mixed with the reaction gas mixture and subsequently flowed to a heated zone with a catalyst that promotes the combustion.

The oxygen may be as pure as desired for the subsequent reactions, or may contain one or more additional constituents, such as nitrogen as may be useful as reaction constituents in subsequent reactions (e.g., using nitrogen in the formation of ammonia). In some embodiments, air may be used as the oxygen source for the direct combustion heater.

The products of combustion in the direct combustion heaters may remain in the heated reaction gas mixture flowing out of the heater. The heated reaction gas mixture may be subsequently reacted to remove one or more constituents of the reaction, cooled to condense and remove water, and recycled as at least part of the reaction gas mixture entering the direct combustion heater.

Application of the direct combustion heaters of this disclosure includes heating a reaction gas mixture to a desired temperature so that the heated reaction gas mixture may be subsequently used in forming carbon-containing products. In some embodiments, the heated reaction gases subsequently react in the presence of a catalyst to form solid carbon products and tail gases. For example, solid carbon products may include allotropes of carbon or morphologies thereof, including graphite, pyrolytic graphite, graphene, carbon black, fibrous carbon, buckminsterfullerenes, single-wall CNTs, multi-walled CNTs, platelets, or nanodiamond. The type, purity, and homogeneity of solid carbon products may be controlled by the reaction conditions (time, temperature, pressure, partial pressure of reactants, and/or catalyst properties). Water formed in the processes may subsequently be condensed, and the latent heat may be extracted for heating purposes, or as part of a low-pressure power-extraction cycle. The water may be treated to remove any dissolved reaction gases, filtered to remove solid contaminants, and/or released the environment. In general, pure water may be formed as a co-product of some embodiments of the processes disclosed herein. In some embodiments, the partial pressure of water in the reaction is regulated by various means, including recycling and condensation of water, to influence, e.g., the structure or other aspects of the composition of carbon products produced.

In some embodiments, the methods disclosed herein use an oxidizing gas and a reducing gas to form heated carbon oxides. The methods may also involve catalytic conversion of the heated carbon oxides to solid carbon and water. The carbon oxides may be purified and concentrated as needed, and as described herein. High-purity carbon oxides and reducing agents may yield high-purity solid carbon products. The oxidizing gas may be oxygen, air, or any other oxidant. In certain embodiments, the solid carbon product includes one or more allotropes of carbon nanotubes. Spatial and temporal coupling of a heat-producing oxidation stage with a reduction stage for production of solid carbon may improve efficiencies of CNT production and reduce costs.

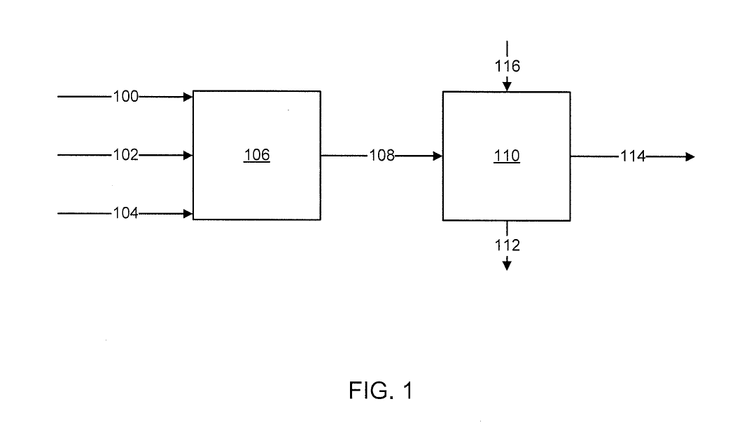

FIG. 1 is a simplified process flow diagram illustrating direct combustion methods and systems in which such methods may be performed. An oxidizing gas 100, a reducing gas 102, and optionally, inert gases 104 enter a direct combustion heater 106, wherein the oxidizing gas 100, the reducing gas 102, and the inert gases 104 (if present) mix with one another. Alternatively, inert gases 104 may be mixed with the oxidizing gas 100 or the reducing gas 102 before the oxidizing gas 100 or the reducing gas 102 enter the direct combustion heater 106. The oxidizing gas 100 may include, for example, oxygen, ozone, oxides of nitrogen, etc. The reducing gas 102 may include hydrogen, hydrocarbons, alcohols, etc. For example, the reducing gas 102 may include a hydrocarbon (i.e., a compound having only carbon and hydrogen) having eight or fewer carbon atoms, six or fewer carbon atoms, four or fewer carbon atoms, etc. The inert gases 104, if present, may include nitrogen, carbon dioxide, argon, water, etc. Though referred to herein as “inert,” inert gases may react under other conditions, as described in further detail below, but not under the conditions of the direct combustion heater 106. The direct combustion heater 106 may be maintained at a temperature above a reaction temperature of the reducing gas 102 with the oxidizing gas 100, such that upon introduction of the gases to the direct combustion heater 106, the oxidizing gas 100 reacts with the reducing gas 102 to produce heat and form at least one carbon oxide and water. For example, if the oxidizing gas 100 includes oxygen and the reducing gas 102 includes methane, reaction of the methane with the oxygen may form water and a carbon oxide (carbon monoxide and/or carbon dioxide), as shown in Reactions 1 and 2:

CH₄+2O₂ [symbol] CO₂+2H₂O (Reaction 1);

2CH₄+3O₂ [symbol] 2CO+4H₂O (Reaction 2).

A reaction gas mixture 108 leaving the direct combustion heater 106 includes products of the reaction of the oxidizing gas 100 with the reducing gas 102, any inert gases 104, and any unreacted portions of the oxidizing gas 100 or the reducing gas 102. The reaction gas mixture 108 typically includes at least one carbon oxide. For example, the reaction gas mixture 108 may include carbon monoxide, carbon dioxide, water, and nitrogen if the inert gases 104 include nitrogen (e.g., if the oxidizing gas 100 and inert gases 104 are introduced together as air).

The direct combustion heater 106 may be formed of a material selected or formulated to withstand the expected conditions therein. For example, the direct combustion heater 106 may be lined with a ceramic material capable of withstanding high-temperature corrosive or metal-dusting environments. Some reaction gas mixture 108, such as those containing significant amounts of carbon oxides, may react with metals, such as steel, stainless steel, and other alloys. Therefore, it may desirable to avoid exposing the reaction gas mixture 108 to such metals. Though such metals may be used in the construction of the direct combustion heater 106, the metals may be coated with a protecting material, or may be used as structural support for other materials (e.g., ceramics).

Reactions in the direct combustion heater 106 heat the reaction gas mixture 108, such as to at least 600° C., at least 800° C., at least 1000° C., at least 1500° C., or even at least 2000° C. The reaction gas mixture 108 may leave the direct combustion heater 106 at a temperature appropriate to carry out further reactions, or at a temperature such that the need for subsequent heating is reduced. Heating of the reaction gas mixture 108 may also increase the pressure of the reaction gas mixture 108 leaving the direct combustion heater 106. For example, the reaction gas mixture 108 may be at a pressure in a range of from about atmospheric pressure to in excess of about 6.2 MPa (900 psi). In some embodiments, the reaction gas mixture 108 may be at a pressure from about 0.34 MPa (50 psi) to about 0.41 MPa (60 psi), or at a pressure of about 4.1 MPa (600 psi).

The reaction gas mixture 108 leaves the direct combustion heater 106 and enters a reactor 110. The reaction gas mixture 108 reacts in the presence of a catalyst within the reactor 110 to form a product 112 and a tail gas 114. The product 112 may be a solid, such as solid carbon, or a liquid, such as a hydrocarbon. The product 112 may also include some catalyst material, such as in growth tips of CNTs. The catalyst may optionally be continuously added via a catalyst stream 116 to replenish any material leaving the reactor 110 in the product 112.

The reactor 110 may be maintained at a temperature higher than the temperature of the reaction gas mixture 108, such that the reaction gas mixture 108 is heated upon entry into the reactor 110. In some embodiments, reactions taking place within the reactor 110 may be exothermic, and the reactor 110 may operate without any further heat input.

Various reactions may occur within the reactor 110, such as Bosch reactions, Fischer-Tropsch reactions, ammonia-forming reactions, or any other reactions involving one or more components of the reaction gas mixture 108. Conditions within the reactor 110 may be selected to promote any selected reaction chemistry.

For example, the reactor 110 may be operated at conditions conducive to Bosch reactions. In Bosch reactions, hydrogen, hydrocarbons, alcohols, or mixtures thereof reduce carbon oxides (e.g., carbon dioxide, carbon monoxide, or mixtures thereof) to solid carbon (e.g., graphite, graphene, carbon black, fibrous carbon, buckminsterfullerene, single-wall CNTs, multi-walled CNTs, platelets, nanodiamond, etc.) and water. In such embodiments, the water produced typically leaves the reactor 110 as a component of the tail gas 114. The solid carbon typically leaves the reactor 110 as the product 112. Bosch reactions may be conducted at temperatures from approximately 450° C. to approximately 1,000° C. in the presence of a catalyst such as iron, iron- and carbon-containing compounds such as cementite, and a wide variety of other metals including nickel, cobalt, molybdenum, and mixtures thereof. The Bosch reaction of carbon dioxide and hydrogen to form solid carbon proceeds with the stoichiometry shown in Reaction 3:

CO₂+2H₂ [symbol] C_{(solid)}+2H₂O (Reaction 3)

The Bosch reaction is believed to be a two-step reaction with an overall release of energy (i.e., the reaction is exothermic). In the first step of the reaction, shown in Reaction 4, carbon dioxide reacts with hydrogen to form carbon monoxide and water in a reverse water-gas shift reaction:

CO₂+H₂ [symbol] CO+H₂O (Reaction 4).

In the second step of the reaction, CO reacts with hydrogen in the presence of a catalyst to form solid carbon and water, as shown in Reaction 5:

CO+H₂ [symbol] C_{(solid)}+H₂O (Reaction 5).

The reaction shown in Reaction 3 may occur with stoichiometric amounts of reactants, or with excess CO₂ or H₂. The Bosch family of reactions may form various allotropes and morphologies of carbon, as described in International Patent Publication No. WO 2013/158157, published Oct. 24, 2013, and entitled “Methods and Reactors for Producing Solid Carbon Nanotubes, Solid Carbon Clusters, fnd Forests.” Reaction conditions may be optimized to produce a particular desired type of solid carbon. The reaction of the oxidizing gas 100 with the reducing gas 102 in the direct combustion heater 106 may provide heat to maintain reaction conditions favorable to formation of products 112 within the reactor 110, and may also provide carbon oxides as part of the reaction gas mixture 108.

In some embodiments, the reactor 110 may be operated at conditions conducive to Fischer-Tropsch reactions. In Fischer-Tropsch reactions, hydrogen converts carbon monoxide to hydrocarbons (generally alkanes) and water. In such embodiments, the water and hydrocarbons may leave the reactor 110 together as a gas, and may be subsequently separated into the product 112 and the tail gas 114 in another operation. Separation processes are known in the art not described in detail herein. Fischer-Tropsch reactions may be conducted at temperatures from approximately 100° C. to approximately 500° C. in the presence of a catalyst such as cobalt. Fischer-Tropsch reactions are described in U.S. Pat. No. 1,746,464, granted Feb. 11, 1930, and entitled “Process for the Production of Parrafin-Hydrocarbons with More Than One Carbon Atom.” The Fischer-Tropsch reaction of carbon monoxide and hydrogen to form ethane proceeds with the stoichiometry as shown in Reaction 6:

2CO+3H₂ [symbol] 2C₂H₆+2H₂O (Reaction 6).

The reaction shown in Reaction 6 may occur with stoichiometric amounts of reactants, or with excess CO or H₂. The reaction of the oxidizing gas 100 with the reducing gas 102 in the direct combustion heater 106 may provide heat to maintain reaction conditions favorable to formation of products 112 within the reactor 110, and may also provide carbon monoxide as part of the reaction gas mixture 108.

In some embodiments, the reactor 110 may be operated at conditions conducive to reactions that form ammonia. For example, carbon oxides, hydrogen, and nitrogen may react to form solid carbon, ammonia, and water. In such embodiments, the water and ammonia may leave the reactor 110 together as the tail gas 114, and the solid carbon may leave as the product 112. The tail gas 114 may be subsequently separated into ammonia and water in another operation, such as a scrubber. Separation processes are known in the art not described in detail herein. Ammonia-forming reactions may be conducted at temperatures from approximately 550° C. to approximately 1200° C., such as from approximately 650° C. to approximately 800° C., in the presence of a catalyst. Ammonia may be formed from carbon oxides according to the stoichiometry shown in Reactions 7 and 8:

CO₂+N₂+5H₂ [symbol] C_{(solid)}+2H₂O+2NH₃ (Reaction 7);

CO+N₂+4H₂ [symbol] C_{(solid)}+H₂O+2NH₃ (Reaction 8).

In some embodiments, ammonia may be formed from reactions with hydrogen, hydrocarbons or other reducing gases. Ammonia-forming reactions of carbon oxides are described in International Patent Publication No. WO 2014/011206, published Jan. 16, 2014, and entitled “Methods and Systems for Forming Ammonia and Solid Carbon Products.”

The ammonia-forming reactions shown in Reactions 7 and 8 may occur with stoichiometric amounts of reactants, or with excess CO, CO₂, N₂, or H₂. The reaction of the oxidizing gas 100 with the reducing gas 102 in the direct combustion heater 106 may provide heat to maintain reaction conditions favorable to the formation of products 112 within the reactor 110, and may also provide carbon oxides as part of the reaction gas mixture 108.

The reactor 110 may be operated at conditions conducive to various other reactions involving components of the reaction gas mixture 108. The product 112 and/or the tail gas 114 may be further processed as necessary or desirable to form solids, liquids, or gases of a selected purity or form.

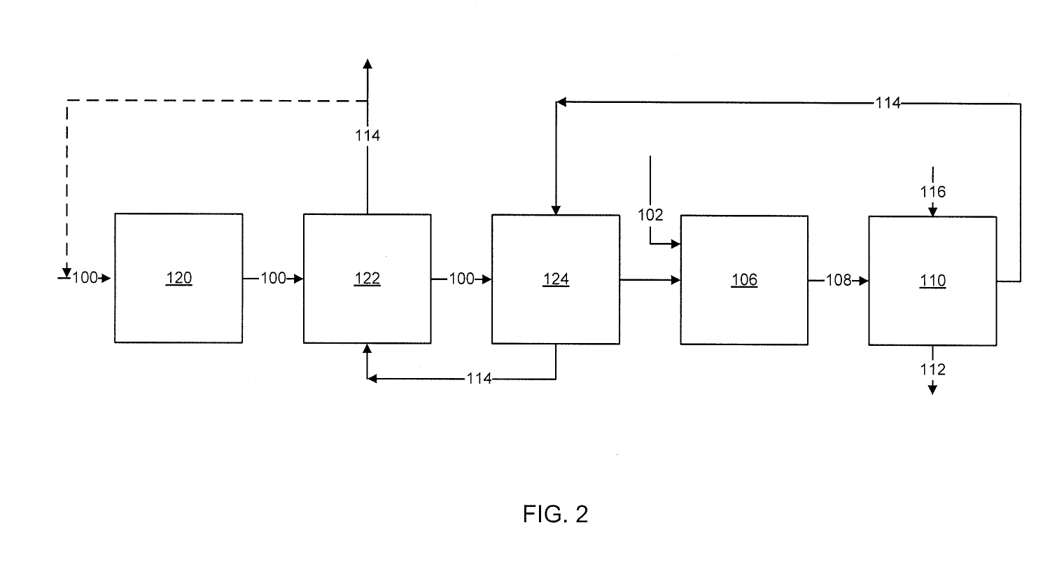

The direct combustion heater 106 and reactor 110 may be used in conjunction with other unit operations, for example as shown in FIG. 2. In the system and process shown in FIG. 2, some gases entering the direct combustion heater 106 are preheated by recovering heat from the tail gas 114. The oxidizing gas 100 (which may also include one or more inert gases) enters a compressor 120 or pump, after which the oxidizing gas 100 is heated by transferring heat from the tail gas 114 in one or more heat exchangers 122, 124. The oxidizing gas 100 mixes with the reducing gas 102 in the direct combustion heater 106 as described above, before the resulting reaction gas mixture 108 enters the reactor 110. In some embodiments, a portion of the tail gas 114 may be recycled by mixing with the oxidizing gas 100 entering the compressor 120, as shown by a dashed line in FIG. 2.

Various catalysts may be used to facilitate one or more reactions described herein. Catalysts may facilitate operations at lower temperatures in comparison to uncatalyzed reactions, and may influence the morphology of solid carbon products formed. In reactions forming CNTs, for example, higher reaction rates may correspond to smaller-diameter CNTs, and lower reaction rates may correspond to larger-diameter CNTs. In certain embodiments, catalytic conversion of carbon oxides (e.g., carbon monoxide, carbon dioxide) to solid carbon and water is facilitated using a suitable catalyst. Suitable catalysts include metals selected from groups 2 through 15 of the periodic table (e.g., nickel, molybdenum, chromium, cobalt, tungsten, manganese, ruthenium, platinum, iridium, etc.), actinides, lanthanides, alloys thereof, and combinations thereof. For example, catalysts may include iron, nickel, cobalt, molybdenum, tungsten, chromium, and alloys thereof. Note that the periodic table may have various group numbering systems. As used herein, group 2 is the group including Be, group 3 is the group including Sc, group 4 is the group including Ti, group 5 is the group including V, group 6 is the group including Cr, group 7 is the group including Mn, group 8 is the group including Fe, group 9 is the group including Co, group 10 is the group including Ni, group 11 is the group including Cu, group 12 is the group including Zn, group 13 is the group including B, group 14 is the group including C, and group 15 is the group including N. In certain embodiments, the catalyst includes intermetallic compounds, such as Ni₃Fe, a nickel-iron intermetallic, or Fe₃Pt, an iron-platinum intermetallic. In some embodiments, commercially available metals are used without special preparation.

The use of commercial forms of commonly-available metals may reduce the cost, complexity, and difficulty of producing solid carbon. For example, CNT forests may grow on commercial grades of steel, with the CNT forests forming directly on the steel without additional layers or surfaces isolating the steel from the CNT forest. CNTs form on materials such as on mild steel, 304 stainless steel, 316L stainless steel, steel wool, and 304 stainless steel wire. 304 stainless steel appears to catalyze the formation of CNTs under a wide range of temperatures, pressures, and gas compositions. 316L stainless steel, in contrast, appears to catalyze the formation of solid carbon at significantly higher rates than 304 stainless steel under most conditions, but may also form various non-CNT morphologies of carbon. Thus, 316L stainless steel may be used as a catalyst to achieve high reaction rates, but particular reaction conditions may be maintained to control product morphology. Catalysts may be selected to include Cr, such as in amounts of about 22% or less by weight. For example, 316L stainless steel contains from about 16% to about 18.5% Cr by weight. Catalysts may also be selected to include Ni, such as in amounts of about 8% or more by weight. For example, 316L stainless steel contains from about 10% to about 14% Ni by weight. Given the favorable results observed with 316L stainless steel, the Ni and/or Cr may have a synergistic effect with Fe.

Iron alloys, including steel, may contain various allotropes of iron, including alpha-iron (austenite), gamma iron, and delta-iron. Catalysts of these types of steel contain iron in an austenitic phase, in contrast to alpha-phase iron used as a catalyst in certain conventional processes. In some embodiments, reactions disclosed herein advantageously utilize an iron-based catalyst, wherein the iron is not in an alpha phase. In certain embodiments, a stainless steel containing iron primarily in the austenitic phase is used as a catalyst. In certain embodiments, a broad range of inexpensive and readily-available catalysts, including steel-based catalysts, are described, without the need for activation of the catalyst before it is used in a reaction.

In some embodiments, the iron may be reacted to form an iron carbide. The use of iron carbides in such cases may have several advantages including higher reaction rates in catalyzing the formation of solid carbon products including CNTs and, if small particles are used as the catalyst, in not sintering at the reaction temperatures.

Some gases, such as oxygen, are detrimental to some catalysts. For example, the presence of oxygen may poison a catalyst, such as by reacting with materials to form solids that adhere to or deposit on catalyst surfaces. To prevent such damage, oxygen not consumed in the direct combustion heater 106 may be removed or reacted with another material before entering the reactor 110. For example, oxygen may be removed by contacting the reaction gas mixture 108 with a ceramic configured to allow oxygen to pass through the ceramic (e.g., a ceramic doped with an oxide of Zr, Ca, Mg, Y, V, Nb, Ta, Cr, Mo, Mn, Fe, W, and/or Ti), as described in U.S. Pat. No. 5,624,542, issued Apr. 29, 1997, and entitled “Enhancement of Mechanical Properties of Ceramic Membranes and Solid Electrolytes;” U.S. Pat. No. 5,910,238, issued Jun. 8, 1999, and entitled “Microspheres for Combined Oxygen Separation, Storage and Delivery;” or U.S. Pat. No. 5,021,137, issued Jun. 4, 1991, and entitled “Ceramic Solid Electrolyte Based Electrochemical Oxygen Concentrator Cell.”

A wide variety of reactor designs may be used to facilitate the formation of the product 112 in the reactor 110. Aerosol and fluidized bed reactors are particularly suitable for high-volume continuous production of the product 112. A fluid-wall reactor has the advantages of providing for the introduction of various substances (e.g., catalyst via the catalyst stream 116, additional reactants) and of minimizing or eliminating the accumulation of the product 112 on reactor walls.

In some embodiments, the reactor 110 includes two or more reaction zones, with a first, oxidative stage taking place in a first reaction zone, without a catalyst, and a second, reductive stage, taking place in a second reaction zone containing a suitable catalyst. Physical separation of the two-stage process reduces premature formation of a carbon product. In certain embodiments, a reaction gas mixture including carbon oxides is formed in the first reaction zone using reactions disclosed herein, then the reaction gas mixture passes into a second reaction zone, where at least a portion of the carbon oxides are reacted to form solid carbon.

In some embodiments, the reactor 110 may be an aerosol reactor in which catalyst material is preformed and selected for a specific size distribution, mixed into a liquid or carrier gas solution, and then sprayed into the reactor (e.g., via electrospray). In another embodiment, the reactor 110 may include one or more fluidized-bed reactors in which catalyst particles or catalyst-coated particles are introduced into the reactor 110 and the product 112 is grown as a solid material on the surface of the particles. The product 112 may be either elutriated in the reactor 110, and carried out of the reactor 110 entrained in the reaction gases, or the catalyst particles may be harvested and the product 112 subsequently removed from the surface.

The reactor 110 may contain the catalyst as a fixed solid surface or a material mounted on a fixed solid surface (e.g., catalyst nanoparticles deposited on an inert substrate). In such embodiments, the product 112 is grown on the catalyst, and the catalyst and product 112 are periodically removed from the reactor. Alternatively, the reactor 110 may operate continuously, such that the product 112 is continuously removed from the catalyst, or the catalyst is continuously removed with the product 112 and replenished via the catalyst stream 116. In some embodiments, a solid catalyst or catalyst mounted on a solid substrate is moved through a flowing gas stream, the resulting product 112 is harvested, the catalyst is reconditioned, and the catalyst is reintroduced to the reactor 110. The solid substrate may be the catalyst material (e.g., a solid piece of steel or other alloy of catalyzing elements such as iron-, chromium-, molybdenum-, cobalt-, or nickel-containing alloys or superalloys) or a surface on which the catalyst is mounted. Catalysts, including an iron-based catalyst (e.g., steel, steel wool), may be used without a need for an additional solid support. In certain embodiments, reactions disclosed herein proceed without the need for a ceramic or metallic support for the catalyst. Omitting a solid support may simplify the setup of the reactor and reduce costs.

In one embodiment, the reactor 110 may be a fluidized-bed reactor configured to retain the catalyst material while allowing the product 112 to be entrained in the gas flow and to be lofted out of a reaction zone upon reaching a desired size. The size of particles leaving the reaction zone may depend on the shape of the reactor, the gas flow rates, or shape and flow rates in combination. The size of particles leaving the reaction zone may be selected or varied to control the residence time of the elutriates and the corresponding size of particles of the product 112 (such as the length of CNTs).

In one embodiment, particles in a fluidized-bed reactor are of a substantially uniform diameter or length. The dimensions of the catalyst in the fluidized bed may be chosen based on the configuration of the reactor 110, the flow rate of the reactants through the reactor 110, the shape of the catalyst, the density of the catalyst, and the density of the reactant gases and any inert gases that may be used. The dimensions of the catalyst particles may be selected to avoid entrainment of the catalyst with the product 112 and also to avoid channeling of the reactants through the bed. A diffuser or sparger may be employed through which the gaseous reactants pass to provide a uniform flow pattern among the particles of the fluidized bed without channeling of gas through the particle bed.

Small amounts of substances (e.g., sulfur) added to the reaction zone may be catalyst promoters that accelerate the growth of the product 112 on the catalyst. Such promoters may be introduced into the reactor in a wide variety of compounds. Such compounds may be selected such that the decomposition temperature of the compound is below the reaction temperature. For example, if sulfur is selected as a promoter for an iron-based catalyst, the sulfur may be introduced into the reaction zone as a thiophene gas, or as thiophene droplets in a carrier gas. Examples of sulfur-containing catalyst promoters include thiophene, hydrogen sulfide, heterocyclic sulfide, and inorganic sulfide. Other catalyst promoters include lead compounds and bismuth.

The system and process shown in FIG. 2 may be selected and configured to recover some of the heat generated in the direct combustion heater 106 and the reactor 110. In so doing, the system may require a smaller energy input than in a similar system in which heat is not recovered.

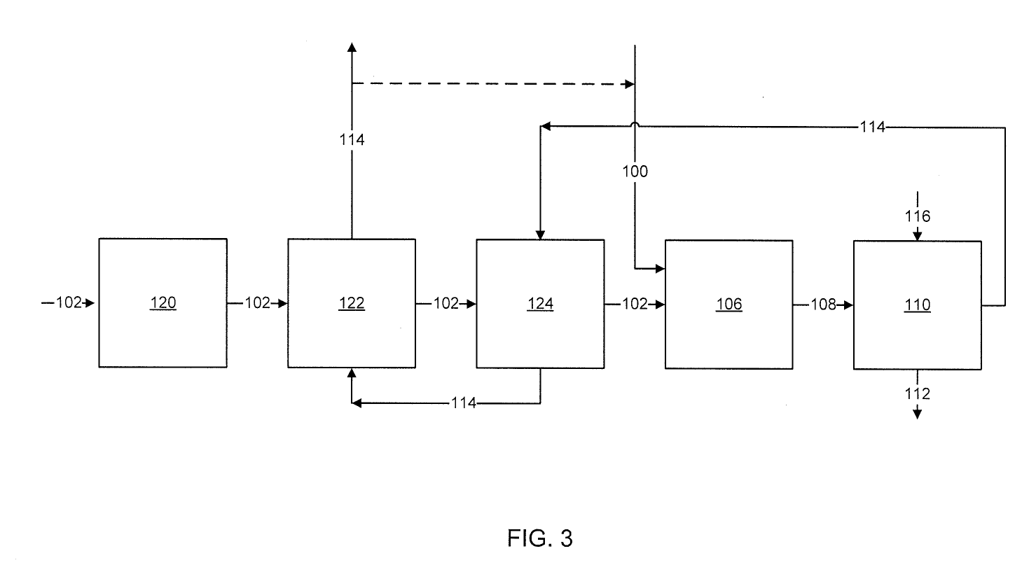

Another system in which the direct combustion heater 106 and reactor 110 are used in conjunction with other unit operations is shown in FIG. 3. The reducing gas 102 enters a compressor 120 or pump, after which the reducing gas 102 is heated by transferring heat from the tail gas 114 in one or more heat exchangers 122, 124. The reducing gas 102 mixes with the oxidizing gas 100 (which may also include one or more inert gases) in the direct combustion heater 106 as described above, before the resulting reaction gas mixture 108 enters the reactor 110. In some embodiments, a portion of the tail gas 114 may be recycled by mixing with the oxidizing gas 100 entering the direct combustion heater 106, as shown by a dashed line in FIG. 3.

In the systems shown in FIGS. 2 and 3, the inert gases (if present) may be mixed with the oxidizing gas 100 as described, with the reducing gas 102, directly into the direct combustion heater 106, or directly into the reactor 110. Addition of the inert gases may affect the heat balance of the system, and the amount and point of entry of the inert gases may vary.

In some embodiments, the system and process may include other unit operations, such as a water removal device, a solids separation device, etc. For example, the system may include a condenser to remove water from the tail gas 114, such that a substantially dry tail gas 114 may be recycled through the system.

In some embodiments, one or more of the oxidizing gas 100, the reducing gas 102, and the inert gases 104 may purified before entering the direct combustion heater 106. Instead, or in addition, the reaction gas mixture 108 may be purified before entering the reactor 110. Such purification may include, for example, removing particulates, removing inert gases, or condensing water

Solid product 112 may be collected and separated from the tail gas 114 or from solid surfaces on which they form, such as by elutriation, centrifugation, electrostatic precipitation, or filtration. In some embodiments, the system may include one or more filters to remove particulate material, such as from the oxidizing gas 100, the reducing gas 102, the inert gases 104, the reaction gas mixture 108, or the tail gas 114. For example, the tail gas 114 may be filtered to remove substantially all particulate material, or an amount of particulate material selected to comply with environmental regulations.

The techniques for separation of solid products from the tail gas 114 may depend on the type of reactor used. In one embodiment, a cyclone separator is used to separate and collect the product 112. For a solid catalyst or solid-surface-mounted catalyst, the product 112, if solid, may be scraped or otherwise abraded from the surface of the catalyst. Alternatively, when using a solid catalyst, the product 112 may be rinsed off a surface with a solvent for further processing.

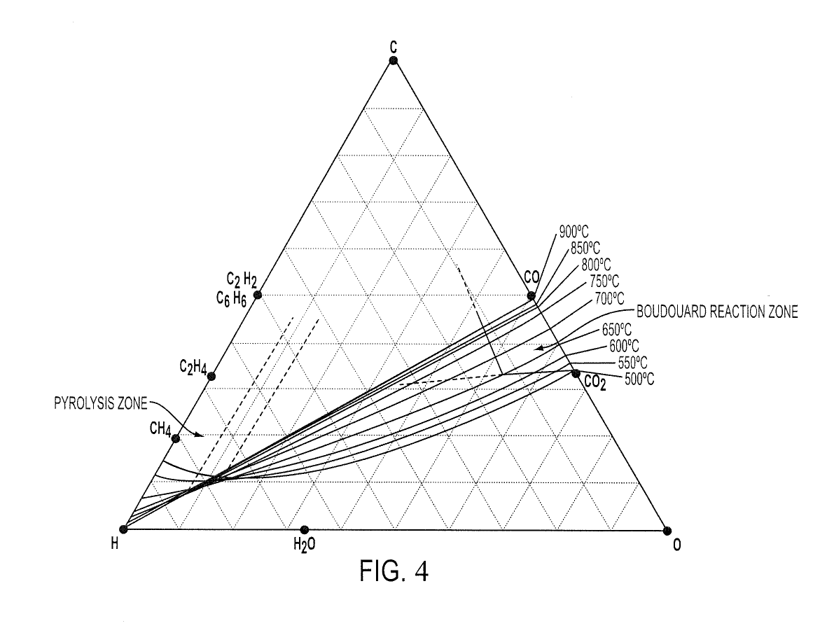

The systems and processes described herein may involve reactions in the interior region of the C—H—O equilibrium phase diagram shown in FIG. 4, including multi-step reactions, where equilibrium may be established between oxygen, hydrogen, solid carbon, and compounds of carbon, hydrogen, and/or oxygen. The central region of FIG. 4 has several points that are favorable for the formation of CNTs and other valuable allotropes and associated morphologies of solid carbon. The type of solid carbon produced may be selectively controlled through selection and processing of the catalysts, reaction gas mixtures, and reaction conditions.

Solid carbon may be produced in several different allotropes of carbon and in various morphologies of these allotropes through the reduction of carbon oxides. Some of the solid carbon allotropes and morphologies that may be produced include graphite (e.g., pyrolytic graphite), graphene, carbon black, fibrous carbon, buckminsterfullerene, single-wall CNTs, multi-walled CNTs, platelets, and nanodiamond.

The reaction conditions, including the temperature and pressure in the reaction zone, the residence time of the reaction gases, and the grain size, grain boundary, and chemical composition of the catalyst may be controlled to obtain solid carbon products of the desired characteristics. The feed gas mixture and reaction product are typically recycled through the reaction zone and passed through a condenser with each cycle to remove excess water and to control the partial pressure of the water vapor in the reaction gas mixture. The partial pressure of water is one factor that appears to affect the type and character (e.g., morphology) of solid carbon formed, as well as the kinetics of carbon formation. In some embodiments, water partial pressure is regulated to assist in obtaining certain desirable carbon allotropes.

Catalysts may be in the form of nanoparticles or in the form of domains or grains and grain boundaries within a solid material. Catalysts may be selected to have a grain size related to a characteristic dimension of a desired diameter of the solid carbon product (e.g. a CNT diameter). Catalyst powder may be formed in or near the reaction zone by injecting an aerosol solution such that upon evaporation of a carrier solvent, a selected particle size distribution results. Alternatively, powderized catalyst may be entrained in a carrier gas and delivered to the reactor. By selecting the catalyst and the reaction conditions, the process may be tuned to produce selected morphologies of solid carbon product. Catalysts may be formed, for example, as described in U.S. Patent Application Publication No. 2012/0034150. In some embodiments, the catalyst may be formed over a substrate or support, such as an inert oxide that does not participate in the reactions. However, the substrate is not necessary; in other embodiments, the catalyst material is an unsupported material, such as a bulk metal or particles of metal not connected to another material (e.g., loose particles, shavings, or shot, such as may be used in a fluidized-bed reactor).

An optimum reaction temperature may be dependent on the composition of the catalyst and/or on the size of the catalyst particles. Catalyst materials having small particle sizes tend to have optimum reaction temperatures at lower temperatures than the same catalyst materials with larger particle sizes. For example, Bosch reactions may occur at temperatures in the range of approximately 450° C. to 1000° C. for iron-based catalysts, depending on the particle size and composition and the desired solid carbon product. In general, graphite and amorphous solid carbon form at lower temperatures, and CNTs form at higher temperatures. CNTs may form at temperatures above about 600° C. In general, reactions proceed at a wide range of pressures, from near vacuum, to pressures of 4.0 MPa (580 psi) or higher. For example, CNTs may form in pressure ranges of from about vacuum to in excess of about 6.2 MPa (900 psi). In some embodiments, CNTs may be formed at about 0.34 MPa (50 psi) to about 0.41 MPa (60 psi), or at a pressure of about 4.1 MPa (600 psi). Typically, increasing the pressure increases the reaction rate.

Carbon activity (A_{c}) can be used as an indicator of whether solid carbon will form under particular reaction conditions (e.g., temperature, pressure, reactants, concentrations). Without being bound to any particular theory, it is believed that carbon activity is the key metric for determining which allotrope of solid carbon is formed. Higher carbon activity tends to result in the formation of CNTs, lower carbon activity tends to result in the formation of graphitic forms.

Carbon activity for a reaction forming solid carbon from gaseous reactants can be defined as the reaction equilibrium constant times the partial pressure of gaseous products, divided by the partial pressure of reactants. For example, in the reaction, CO_{(g)}+H_{2(g)}⇄C_{(solid)}+H₂O_{(g)}, with a reaction equilibrium constant of K, the carbon activity A_{c} is defined as K·(P_{CO}·P_{H2}/P_{H2O}). Thus, A_{c} is directly proportional to the partial pressures of CO and H₂, and inversely proportional to the partial pressure of H₂O. Changing the partial pressure of water vapor changes the carbon activity of a mixture. Higher P_{H2O} tends to inhibit CNT formation. By removing some of the water vapor in the recycled gases, the morphology of solid carbon formed may thus be controlled. The carbon activity of this reaction may also be expressed in terms of mole fractions and total pressure: A_{c}=K·P_{T}(Y_{CO}·Y_{H2}/Y_{H2O}), where P_{T} is the total pressure and Y is the mole fraction of a species. Carbon activity generally varies with temperature because reaction equilibrium constants vary generally with temperature. Carbon activity also varies with total pressure for reactions in which a different number of moles of gas are produced than are consumed. Mixtures of solid carbon allotropes and morphologies thereof can be achieved by varying the catalyst and the carbon activity of the reaction gases in the reactor.

Oxidation and subsequent reduction of the catalyst surface alter the grain structure and grain boundaries. Without being bound by any particular theory, oxidation appears to alter the surface of the metal catalyst in the oxidized areas. Subsequent reduction may result in further alteration of the catalyst surface. Thus, the grain size and grain boundary of the catalyst may be controlled by oxidizing and reducing the catalyst surface and by controlling the exposure time of the catalyst surface to the reducing gas and the oxidizing gas. The oxidation and/or reduction temperatures may be in the range from about 500° C. to about 1,200° C., from about 600° C. to about 1,000° C., or from about 700° C. to about 900° C. The resulting grain size may range from about 0.1 μm to about 500 μm, from about 0.2 μm to about 100 μm, from about 0.5 μm to about 10 μm, or from about 1.0 μm to about 2.0 μm. In some embodiments, the catalyst may be an oxidized metal (e.g., rusted steel) that is reduced before or during a reaction forming solid carbon. Without being bound to any particular theory, it is believed that removal of oxides leaves voids or irregularities in the surface of the catalyst material, and increases the overall surface area of the catalyst material.

In any of the operations shown in the figures and described herein, controllers may be configured to maintain selected conditions, as indicated by signals received from one or more sensors. For example, the systems may include appropriate means for material handling, mixing, controlling temperature, controlling pressure, etc.

A reactor may be coupled with heating and cooling mechanisms to control the temperature of the reactor. For example, a reactor may be configured such that products and excess reactant are recycled through a cooling mechanism to condense water vapor. The products and/or excess reactant may then be reheated and recycled through the reactor. The reactor may also be coupled to a carbon collector in which water and unreacted reactants are separated from the carbon products. The separated carbon products are collected and removed from the system.

The use of combustion heaters 106, as shown and described in FIGS. 1 through 3, provides a means to preheat reaction gases. Because the combustion products formed in the direct combustion heater 106 can be used as reactants in the reactor 110, removal of combustion products such as carbon oxides is not necessary. Furthermore, water need not be removed from the reaction gas mixture 108 if water does not interfere with the reactions expected to occur in the reactor 110.

### EXAMPLE

Methane gas is mixed with oxygen gas in a ratio of 1:2 and heated at about 600° C. in a heater consisting of a quartz lined 304L stainless steel tube in a tube furnace. The methane gas reacts with the oxygen to form a reaction gas mixture of carbon dioxide, carbon monoxide, water, and oxygen and raises the temperature of the reaction gases to the desired temperature of approximately 680° C. The reaction gas mixture enters a packed-bed reactor having steel wool packing and maintained at about 680° C. The reaction gas mixture forms carbon nanotubes on the exposed surfaces of the steel wool. After the reaction, the steel wool is cooled and removed from the reactor, and the carbon nanotubes are physically removed from the steel wool. Any remaining metal on the carbon nanotubes may be removed, if desired, by washing with acid.

1. A method, comprising:
mixing oxygen with a reducing gas in a vessel having an interior temperature above a reaction temperature of the reducing gas with oxygen;
reacting at least a portion of the oxygen with at least a portion of the reducing gas to form at least one carbon oxide in a heated reaction gas mixture; and
reacting the heated reaction gas mixture in the presence of a catalyst to form a tail gas and at least one of a solid carbon product and a hydrocarbon.

2. The method of claim 1, wherein mixing oxygen with a reducing gas comprises mixing the oxygen with the reducing gas in a vessel having an interior temperature above about 400° C.

3. The method of claim 1, wherein reacting at least a portion of the oxygen with at least a portion of the reducing gas comprises reacting at least a portion of the oxygen with at least a portion of the reducing gas in the presence of a catalyst selected to promote the exothermic reaction of the at least a portion of the oxygen with at least a portion of the reducing gas to form at least one carbon oxide in a heated reaction gas mixture.

4. The method of claim 1, wherein mixing oxygen with a reducing gas comprises mixing air with the reducing gas.

5. The method of claim 1, wherein reacting the heated reaction gas mixture in the presence of a catalyst comprises forming water and a solid carbon product.

6. The method of claim 5, further comprising removing at least a portion of the water from the tail gas.

7. The method of claim 6, wherein removing at least a portion of the water from the tail gas comprises condensing water to form a liquid water stream.

8. The method of claim 6, wherein removing at least a portion of the water from the tail gas comprises removing substantially all the water from the tail gas.

9. The method of claim 1, wherein reacting the heated reaction gas mixture in the presence of a catalyst material comprises reacting carbon monoxide with hydrogen to form water and at least one hydrocarbon.

10. The method of claim 1, wherein reacting the heated reaction gas mixture in the presence of a catalyst material comprises reacting carbon oxide with nitrogen to form solid carbon, water, and ammonia.

11. The method of claim 1, wherein reacting the heated reaction gas mixture in the presence of a catalyst material comprises forming carbon nanotubes.

12. (canceled)

13. The method of claim 1, further comprising preheating at least one of the oxygen and the reducing gas by transferring thermal energy from the tail gas to at least one of the oxygen and the reducing gas.

14-15. (canceled)

16. The method of claim 1, further comprising removing substantially all particulate matter from the tail gas.

17. The method of claim 1, further comprising adding at least one of nitrogen, a carbon oxide, hydrogen, and a hydrocarbon gas to the heated reaction gas mixture.

18. The method of claim 1, wherein the hydrocarbon comprises a compound having eight or fewer carbon atoms.

19. The method of claim 1, further comprising controlling an amount of the oxygen mixed with the reducing gas to limit the interior temperature of the vessel.

20. A reactor system, comprising:
a heater, comprising:
a heater vessel;
a first gas inlet configured to deliver the preheated first feed gas into the vessel;
a second gas inlet configured to deliver a second feed gas into the vessel; and
a gas outlet configured to deliver reaction gas formed from the reaction of at least a portion of the heated first feed gas with at least a portion of the second feed gas; and
a reactor, comprising:
a reactor vessel;
an inlet configured to receive the reaction gas from the heater;
a first outlet configured to deliver a solid or liquid product from the reactor;
a catalyst material formulated to promote the formation of solid carbon and water; and
a tail gas outlet configured to deliver a tail gas from the reactor.

21. (canceled)

22. The system of claim 21, further comprising a heat exchanger configured to transfer heat from the tail gas to the first feed gas before the first feed gas enters the heater.

23. (canceled)

24. The system of claim 20, further comprising a make-up reaction gas inlet configured to deliver at least one of the first feed gas and the second feed gas to the system to maintain a substantially constant mass flow of reaction gas into the reactor.

25. The system of claim 20, wherein the heater further comprises a third gas inlet configured to deliver at least one of nitrogen, a carbon oxide, hydrogen, and a hydrocarbon gas to the vessel.

26-33. (canceled)
